(19) United States
(12) Patent Application Publication
(10) Pub. No.: US 2008/0053961 A1
(43) Pub. Date: Mar. 6, 2008

(54) Metal-clad electrical equipment including a particle trap

(75) Inventor: Wolfgang Grieshaber, Lyon (FR)

Correspondence Address: THELEN REID BROWN RAYSMAN & STEINER LLP, P. O. BOX 640640, SAN JOSE, CA, 95164-0640, US

(73) Assignee: AREVA T&D SA, PARIS LA DEFENSE CEDEX (FR)

(21) Appl. No.: 11/888,702

(22) Filed: Aug. 2, 2007

(30) Foreign Application Priority Data
Aug. 30, 2006 (FR) 06 53516

(51) Int. Cl. H01H 33/02

(52) U.S. Cl. 218/157

(57) ABSTRACT

Metal-clad electrical equipment comprises a metal vessel (4) and an exhaust constituted by an arcing contact support tube (9) and a casing (16) surrounding the support tube (9) and co-operating therewith to define an annular volume (20). At one end, the support tube has an inlet for passing arc gas. Exhaust holes (17) are provided through the casing to allow arc gas to escape into the vessel. The equipment includes a particle trap (22) situated in the exhaust between the arcing contact support tube (9) and the exhaust casing (16).

### TECHNICAL FIELD

The invention relates to a metal-clad electrical equipment comprising a metal vessel and an exhaust constituted by an arcing contact support tube and a casing surrounding the support tube and co-operating therewith to define an annular volume, the support tube having at one end an inlet for passing arc gas, exhaust holes being provided through the casing to allow arc gas to escape into the vessel.

Electrical equipment such as circuit breakers includes arcing contacts that separate in order to break the flow of an electric current. When the equipment is operated, the moving parts (contacts or nozzle) rub against stationary parts, thereby producing small particles that can be insulating or metallic. Hot gas is given off by the arc that appears when the contacts separate. This arc gas flows along the exhaust and blows particles out from the exhaust into the vessel. Unfortunately, the zone situated between the exhaust and the vessel is subjected to an electric field. The particles then collect on the generator line of the vessel and begin to vibrate under the effect of alternating fields. Some of the particles can stand up and give rise to electric fields that are much stronger than inside a clean vessel. These fields can lead to arcs striking between the end of a particle and the casing of the exhaust. Under such circumstances, there is no way in which to extinguish the arc. The equipment then fails.

In order to remedy that drawback, it is known to provide a fine metal sheet in the bottom of the vessel. This sheet has perforations that allow metal particles to pass into the space that exists between the sheet and the bottom of the vessel. Furthermore, the edges of the sheet do not touch the vessel at all locations, thereby also allowing particles to go past the sheet. There is no magnetic field between the metal sheet and the bottom of the vessel. Once the particles are under the fine sheet, they are in a volume where there is not any electric field, so they cease to migrate. They are trapped. Nevertheless, that device presents drawbacks. The electric field that exists on the metal sheet is comparable to the fields that existed previously on the bottom of the vessel. Since this zone is subjected to an electric field, it must satisfy dielectric criteria. In particular, it is necessary to ensure that the edges of the holes are made carefully so as to avoid any edge effects occurring, since that might produce electric fields capable of striking arcs.

It is also known (WO 01/52293) to provide a simple groove in the bottom of the vessel for collecting particles, without providing a metal sheet. Nevertheless, that groove complicates the casting mold somewhat, increases the weight of the casting, and therefore increases its cost. Furthermore, the electric field is not reduced as effectively as when using a fine metal sheet at the bottom of the vessel.

Finally, it is also known to provide a particle trap situated between the vessel and the exhaust casing (U.S. Pat. No. 3,898,408). To hold that particle trap, it is necessary to have an insulating part capable of holding the particle trap around the metal casing of the exhaust, which casing is at high voltage. The particle trap is at a voltage that is intermediate between that of the exhaust casing and that of the cladding. When it is made of an insulating material, it has isopotential lines passing therethrough. That solution then presents two drawbacks. Firstly, the particles are in an electric field zone of strength that is reduced, but the field is not zero. Secondly, the particle trap must be held in that position by an insulating support part. Unfortunately, such a support runs the risk of arcs being triggering by tracking along the surface of the insulation.

A particular object of the present invention is to provide metal-clad equipment that includes a particle trap that remedies those drawbacks.

These objects are achieved by the fact that the equipment includes a particle trap situated in the exhaust between the arcing contact support tube and the exhaust casing.

That solution presents several advantages. The trap is situated in a zone that is not subjected to an electric field. The arcing contact support and the exhaust casing are metal parts at the same potential and they form a Faraday cage. They are connected to the electric circuit by a bus bar. Any electric charge will take up a position on the outermost portion. The electric field becomes established solely in the portion that extends between the outer wall of the exhaust casing and the vessel.

Consequently, the trap may present shapes and may be made out of materials that enable the particle capture rate to be improved, but that would be incompatible with design rules applicable to a zone that is subjected to an electric field. Thus, a grid with pointed metal laminations can be used as the trap in the present invention, even though it would be impossible to put such a trap into a zone that is subjected to an electric field. Furthermore, the trap can be smaller in size.

Preferably, the cross-section of the annular volume in which the particle trap is located is greater than the cross-section of the arcing contact support tube.

Advantageously, the trap is situated in the bottom portion of the exhaust. Preferably, the particle trap is not situated close to the exhaust hole provided through the casing.

In an embodiment, the particle trap comprises elements that are floppy or flexible.

By way of example, the floppy or flexible elements are bristles, lashes, or laminations. The bristles may become curved while gas is escaping. Consequently they do not reduce the flow section available for the gas. Furthermore they serve to retain previously-trapped particles.

Advantageously, the particle trap is made of a material that withstands hot gas.

In another embodiment, the trap is made of a material that is porous or in the form of a foam.

Other characteristics and advantages of the invention appear further on reading the following description of an embodiment given by way of illustration and with reference to the accompanying figures. In the figures:

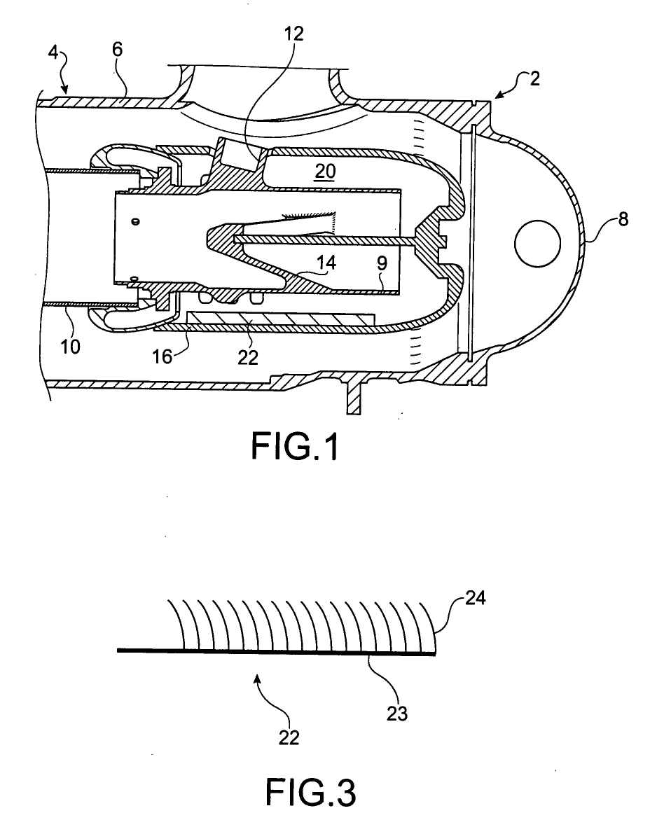

FIG. 1 is a diagrammatic section view of metal-clad electrical equipment in accordance with the present invention;

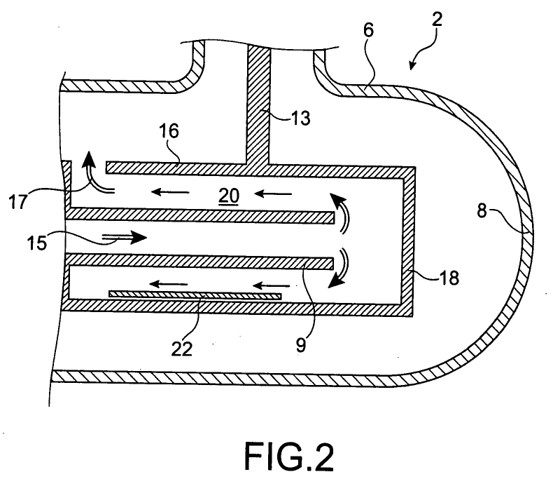

FIG. 2 is a diagram showing the flow of gas within the electrical equipment; and

FIG. 3 is a detail view of a particle trap in accordance with the present invention.

In FIG. 1, overall reference 2 designates metal-clad electrical equipment in accordance with the present invention. The equipment comprises a vessel 4 constituted by a cylindrical container 6 and a hemispherical end 8 mounted at the end shown of the vessel. A similar end is provided at the portion of the vessel that is not shown. The vessel 4 is connected to ground. Inside the vessel there are parking contacts (not shown) for breaking an electric current. An arcing contact support tube 9 is cantilevered out from the end of a nozzle 10. The tube 9 is connected to an electrical bus bar 13 (see FIG. 2) that is received in a socket 12 (FIG. 1). An arcing contact support 14 is provided inside the tube 9. The tube 9 is mounted inside a casing 16 that has an end wall 18. The tube 9 co-operates with the casing 16 to define an annular volume 20.

When breaking a circuit, an arc appears between the arcing contacts. This arc gives rise to hot gas (arc gas) that travels along the tube 9 at high speed from left to right (in FIGS. 1 and 2) as represented by arrow 15 (see FIG. 2). This gas changes direction at the end 18 of the exhaust casing and then travels along the annular volume 20 lying between the outer portion of the tube 19 and the inside wall of the casing 16. The cross-section of the annular volume is greater than the cross-section of the tube 9. As a result, the speed of the gas is slower in the annular volume 20 than in the tube 9. The hot gas then leaves the exhaust via a hole 17 (see FIG. 2) formed through the casing 16.

In accordance with the invention, a particle trap 22 is provided inside the casing 16. The particle trap is situated in a zone that is not subjected to an electric field. The tube 9 and the casing 16 are electrically connected together and are consequently at the same potential. The electric charge spreads over the periphery of the casing 16 and a Faraday cage effect is produced inside the casing. The electric field thus exists between the outside wall of the casing 16 and the vessel 4, the electric field being about five times stronger in the proximity of the casing 16 than in the proximity of the vessel 4. By way of example, the magnitude of the field is 30 kilovolts per millimeter (kV/mm). Given that the particle trap 22 is situated in a zone that is not subjected to an electric field, there is no need for it to be designed in accordance with the rules that apply to zones that are subjected to a dielectric field. Its shape and the material(s) from which it is made can therefore be selected much more freely, and in particular it is possible to select shapes that enable particles to be trapped more effectively. Thus, a grid with pointed metal laminations could be used as a trap in the present invention even though it would be impossible to put the same trap in a zone that is subjected to an electric field. It should also be observed that the particle trap is situated in the bottom portion of the exhaust. Furthermore, its position is remote from the position of the hole 17 provided through the casing 16. Thus, the trap is situated in a zone that is calm, where the speed of the gas is slow.

FIG. 3 shows an embodiment of a particle trap in accordance with the invention. The trap comprises a support 23 carrying flexible lashes or bristles 24. These bristles or lashes lie down while gas is escaping so that they do not reduce the flow section offered to gas. The bristles 24 also serve to retain particles. They prevent particles being entrained away from the exhaust by puffing due to the gas.

In a variant embodiment, the trap is made of a material that is porous or in the form of a foam. Under all circumstances, the material constituting the trap is selected so as to be capable of withstanding hot gas.

1. Metal-clad electrical equipment comprising a metal vessel (4) and an exhaust constituted by an arcing contact support tube (9) and a casing (16) surrounding the support tube (9) and co-operating therewith to define an annular volume (20), the support tube having at one end an inlet for passing arc gas, exhaust holes (17) being provided through the casing to allow arc gas to escape into the vessel, the equipment being characterized in that it includes a particle trap (22) situated in the exhaust between the arcing contact support tube (9) and the exhaust casing (16).

2. Electrical equipment according to claim 1, characterized in that the particle trap is situated in a zone without an electric field.

3. Electrical equipment according to claim 1, characterized in that the cross-section of the annular volume (20) in which the particle trap (22) is located is greater than the cross-section of the arcing contact support tube (8).

4. Electrical equipment according to any one of claim 1, characterized in that the trap (22) is situated in the bottom portion of the exhaust.

5. Electrical equipment according to any one of claim 1 4, characterized in that the particle trap (22) is not situated close to the exhaust hole (17) provided through the casing (16).

6. Electrical equipment according to any one of claim 1, characterized in that the particle trap (22) comprises elements (24) that are floppy or flexible.

7. Electrical equipment according to claim 6, characterized in that the floppy or flexible elements are bristles (24), lashes, or laminations.

8. Electrical equipment according to any one of claim 1, characterized in that the particle trap is made of a material that withstands hot gas.

9. Electrical equipment according to any one of claim 1, characterized in that the trap is made of a material that is porous or in the form of a foam.

10. Electrical equipment according to claim 2, characterized in that the cross-section of the annular volume (20) in which the particle trap (22) is located is greater than the cross-section of the arcing contact support tube (8).
